(19) United States
(12) Patent Application Publication
(10) Pub. No.: US 2009/0214037 A1
(43) Pub. Date: Aug. 27, 2009

(54) Methods and Apparatuses to Secure Data Transmission in RFID Systems Against Eavesdropping

(75) Inventor: John R. TUTTLE, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: KEYSTONE TECHNOLOGY SOLUTIONS, LLC, Boise, ID (US)

(21) Appl. No.: 12/037,646

(22) Filed: Feb. 26, 2008

(51) Int. Cl. H04L 9/00; H04Q 5/22

(52) U.S. Cl. 380/270; 340/10.1

(57) ABSTRACT

Methods and apparatuses to secure data transmission in a radio frequency identification (RFID) system and other Vernam-cipher based cryptography methods against eavesdropping. In one embodiment, a method implemented in an RFID system includes generating an encryption key using previously shared information and random information received in a current communication session and securing a communication in the current session using the encryption key.

### FIELD OF THE TECHNOLOGY

At least some embodiments disclosed herein relate to cryptography in general and, more particularly but not exclusively, to secure data communications between radio frequency identification (RFID) tags and their readers.

### BACKGROUND

In cryptography, a method known as “one-time pad” encrypts a plain text message use a key or “pad” that is as long as the plain text message and is used only once. When used properly, the one-time pad method has the property of “perfect secrecy” where the encrypted message provides no information about the original message, except the length of the original message.

However, various implementation requirements imposed by the proper use of the “one-time pad” method discourage its use in modern communication systems. Thus, alternative methods that do not have the property of “perfect secrecy” are commonly used. For example, some symmetric encryption methods use complex patterns of substitution and transpositions to secure the information, based on the knowledge that there is no known cryptanalytic procedure which can reverse these transformations without knowing the key used during encryption. For example, some asymmetric encryption methods secure the information based on mathematical problems that are thought to be difficult to solve, such as integer factorization and discrete logarithms.

In a current EPCglobal standard for radio frequency identification (RFID), a cover-coding cryptographic scheme is used to provide some protection for certain communications between a RFID reader and a RFID tag. For example, the reader may issue a request for a random number; and in response the tag provides a new 16-bit random number. The reader then generates a 16-bit cipher text through computing the bitwise exclusive OR of the 16-bit random number and the 16-bit message that is to be transmitted from the reader to the tag. After the reader issues a command with the 16-bit cipher text as a parameter, the tag decrypts the received cipher text by computing the bitwise exclusive OR of the 16-bit random number and the received 16-bit cipher text.

### SUMMARY

Described herein are methods and apparatuses to secure data transmission in a radio frequency identification (RFID) system against eavesdropping, using encryption keys generated based on prior shared information. Some embodiments are summarized in this section.

In one embodiment, a method implemented in an RFID system includes generating an encryption key using previously shared information and random information received in a current communication session and securing a communication in the current session using the encryption key.

The present disclosure includes methods and apparatuses which perform these methods, including data processing systems which perform these methods, and computer readable media which when executed on data processing systems cause the systems to perform these methods.

Other features of the disclosure will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a process to transmit a message from a radio frequency identification (RFID) reader to an RFID tag according to one embodiment.

FIG. 2 shows a process to transmit a message from a radio frequency identification (RFID) tag to an RFID reader according to one embodiment.

FIG. 3 shows a system to transmit encrypted messages according to one embodiment.

FIG. 4 shows a system to receive encrypted messages according to one embodiment.

FIG. 5 shows a block diagram of a radio frequency identification (RFID) tag according to one embodiment.

FIG. 6 shows a block diagram of a radio frequency identification (RFID) reader according to one embodiment.

FIGS. 7 and 8 show systems to transmit encrypted messages according to other embodiments.

FIGS. 9 and 10 show methods to transmit blocks of a message via interleaving transmission of blocks of random numbers and blocks of cipher text.

FIG. 11 shows a block diagram of a process to secure data communication according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

At least one embodiment of the disclosure provides a cryptography method which can be used to improve the data security for communications between radio frequency identification (RFID) tags and their readers. The cryptography method can also be used in communications between other devices over various communication channels, such as wireless radio link, Internet, etc.

The cover-coding cryptographic scheme specified in a current EPCglobal standard for radio frequency identification (RFID) is vulnerable to eavesdropping. Since the random number that is to be used as the encryption key is transmitted over the air when the encryption key is needed to transmit a parameter, the random number transmitted over the air can be sniffed by the same eavesdropper who sniffs the encrypted parameter. Thus, the eavesdropper can obtain both the random number and the cipher text by monitoring a communication session to decrypt the transmitted parameter.

In one embodiment of the disclosure, instead of using the random number as the encryption key, a separate encryption key is generated from the random number using additional information not accessible to the eavesdropper. Since the random number obtained by the eavesdropper is not sufficient to generate the key for the decryption of the transmitted message, the use of the separate encryption key prevents the eavesdropper from obtaining a decrypted version of the transmitted message.

For example, a secret shared between the reader and the tag can be used to generate the encryption key which can be a combination of the secret and the random number. The secret is stored in the memory of the reader and the tag. Since the eavesdropper does not have the secret shared between the reader and the tag, the eavesdropper cannot generate the encryption key to decrypt the transmitted message. Thus, the security of the data communication between the reader and the tag is improved.

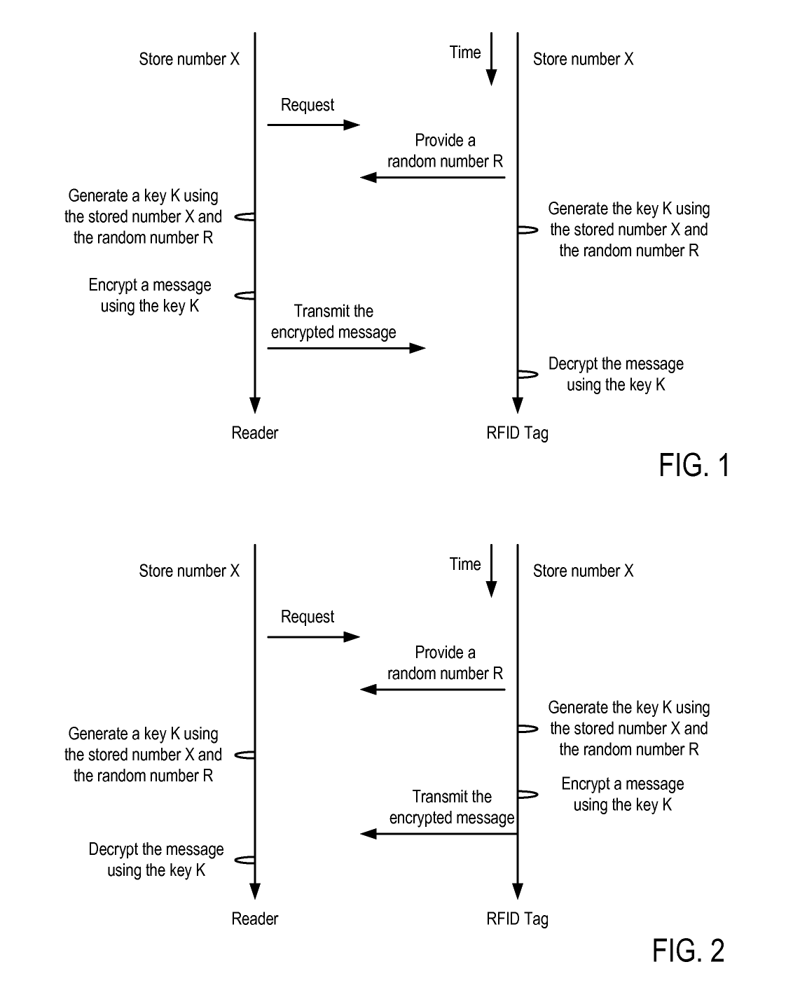

FIG. 1 shows a process to transmit a message from a radio frequency identification (RFID) reader to an RFID tag according to one embodiment. In FIG. 1, the reader and the tag store a number X in their memory. Thus, the number X is a secret to an eavesdropper. In FIG. 1, the secret number X is combined with the transmitted random number R to generate an encryption key K to secure the transmission against eavesdropping.

The number X can be shared between the reader and the tag in various ways. For example, the reader and the tag can share the secret at a secure location through reading from or writing into the tag. The secure location can be electromagnetically shielded to prevent eavesdropping. Alternatively, or in combination, the reader and the tag can share the secret in an earlier communication session. The earlier communication session can be separated from the current communication session by one or more other communication sessions with the same tag and/or with other tags. The earlier communication session can be conducted at a different location out of the current interrogating range of the reader. The earlier communication session can involve a different reader that is out of the current range of the current reader; and the reader used in the earlier communication session can transmit the secret to the current reader via a secure data communication channel.

In FIG. 1, to transmit a message to the tag, the reader sends a request to the tag via an interrogating electromagnetic wave. The request can be an explicit command to request for a random number or an implicit command for other purposes. In response, the tag provides a random number R.

In one embodiment, the RFID tag is a passive tag that does not have an internal battery or power source. The RFID tag operates using the power drawn from the interrogating electromagnetic wave and provides the random number through the modulation of the backscattering of the interrogating electromagnetic wave.

In another embodiment, the RFID tag is a semi-active tag that has an internal battery or power source. The RFID tag operates using the power drawn from the internal battery or power source and provides the random number through the modulation of the backscattering of the interrogating electromagnetic wave.

In a further embodiment, the RFID tag is an active tag that has an internal battery or power source, using which the RFID tag generates a separate transmission signal, independent from the interrogating electromagnetic wave, to provide the random number.

In one embodiment, the random number R is generated in response to the request received from the reader; and the RFID tag generates a new random number in response to each request for a random number.

In FIG. 1, the secret number X is combined with the transmitted random number R to generate an encryption key K. Instead of using the random number R to directly encrypt a message, the reader uses the encryption key K, generated from both the secret number X and the transmitted random number R, to encrypt the message transmitted to the tag. The tag separately generates the same key K, using the stored number X and the newly communicated random number R. After receiving the message encrypted using the implicitly transmitted key K, the tag uses the key K that is independently generated on the tag to decrypt the transmitted message.

Since the stored number X is a secret to the eavesdropper, the communication session is secure against eavesdropping of the transmitted random number and the encrypted message.

FIG. 2 shows a process to transmit a message from a radio frequency identification (RFID) tag to an RFID reader according to one embodiment. In FIG. 2, in response to the reader's request, the tag provides a random number R (e.g., via modulation of backscattering wave or via a response signal). The reader and the tag separately combine the stored number X and the random number R to generate a key K.

In FIG. 2, the tag transmits the encrypted message as part of the response to the request for a random number, after the tag transmits the random number R to the reader. Alternatively, the tag can transmit the encrypted message before the random number R is transmitted to the reader. In another embodiment, the encrypted message is transmitted in response to a separate command/request from the reader.

After obtaining the encrypted message and the random number, the reader decrypts the transmitted message using the key generate from the stored number X and the received random number.

In FIGS. 1 and 2, the encryption key K can be considered a “Ghost” key represented by the random number R. Although the random number R is transmitted explicitly over the air, the “Ghost” key is not sent explicitly over the air. Without the secret number X, the implicit transmission of the “Ghost” key is secure against eavesdropping.

In FIGS. 1 and 2, the random number R is generated and transmitted without using the stored number X. The encryption key K is generated using both the stored number X and the random number R so that an eavesdropper cannot reconstruct the encryption key K from the random number R. For example, the encryption key K can be generated through encrypting the stored number X using the random number R (or encrypting the random number R using the stored number X), or through decrypting the stored number X using the random number R as if the encryption key K were encrypted using the random number R to generate the stored number X (or through decrypting the random number R using the stored number X).

Alternatively, the random number can be sent in an encrypted form, encrypted using the secret number X. The random number decrypted from the transmission can be used as the key that is to be used to encrypt the message transmitted from or to the reader. The random number can be encrypted using the same method to encrypt the message transmitted from or to the reader (e.g., via bitwise exclusive OR, or via a modular adder, or other types of encoders), or using a different method.

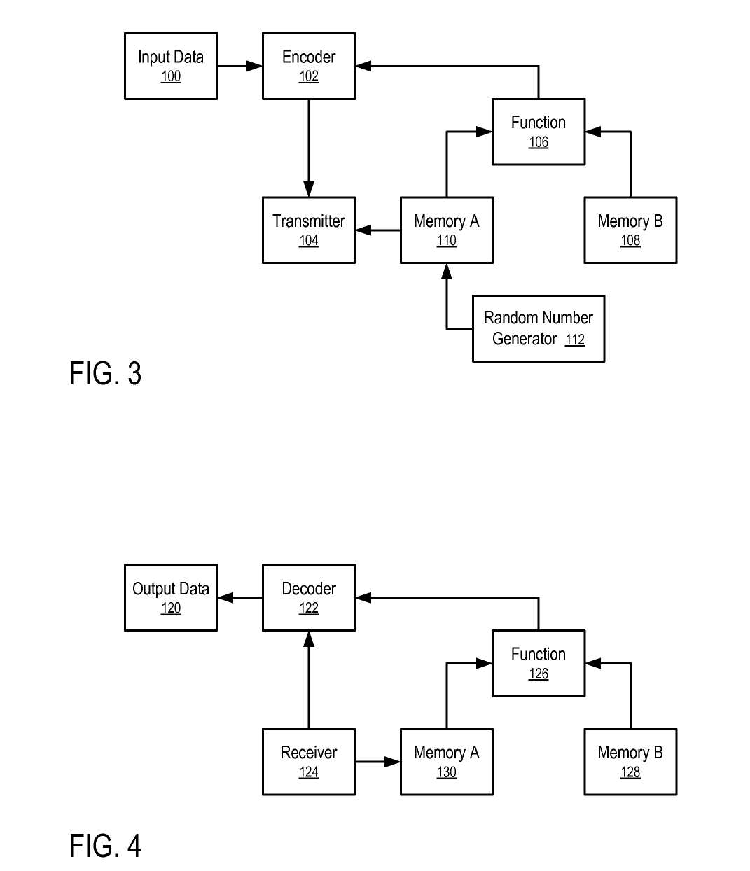

FIG. 3 shows a system to transmit encrypted messages according to one embodiment. In FIG. 3, the transmitting system includes a memory B (108) to store a secret and a memory A (110) to store a random number provided by the random number generator (112). The logic function (106) combines the random number obtained from the memory (110) and the secret obtained from the memory (108) to generate an encryption key for the encoder (102), which encrypts the input data (100) using the encryption key. The transmitter (104) is configured to transmit the encrypted input data obtained from the encoder (102) and the corresponding random number obtained from the memory (110), separately or together.

FIG. 4 shows a system to receive encrypted messages according to one embodiment. In FIG. 4, the receiver (124) is configured to receive the encrypted input data and the corresponding random number (e.g., from the transmitting system of FIG. 3). The receiving system of FIG. 4 includes a memory B (128) to store the same secret as the corresponding memory (108) of the transmitting system of FIG. 3. The memory A (130) is to store the random number obtained from the receiver (124). The logic function (126) combines the random number obtained from the memory A (130) and the secret obtained from the memory B (128) to generate the same encryption key as the transmitting system of FIG. 3. Using the encryption key obtained from the logic function (126), the decoder (122) decrypts the encrypted data obtained from the receiver (124) to generate the output data (120).

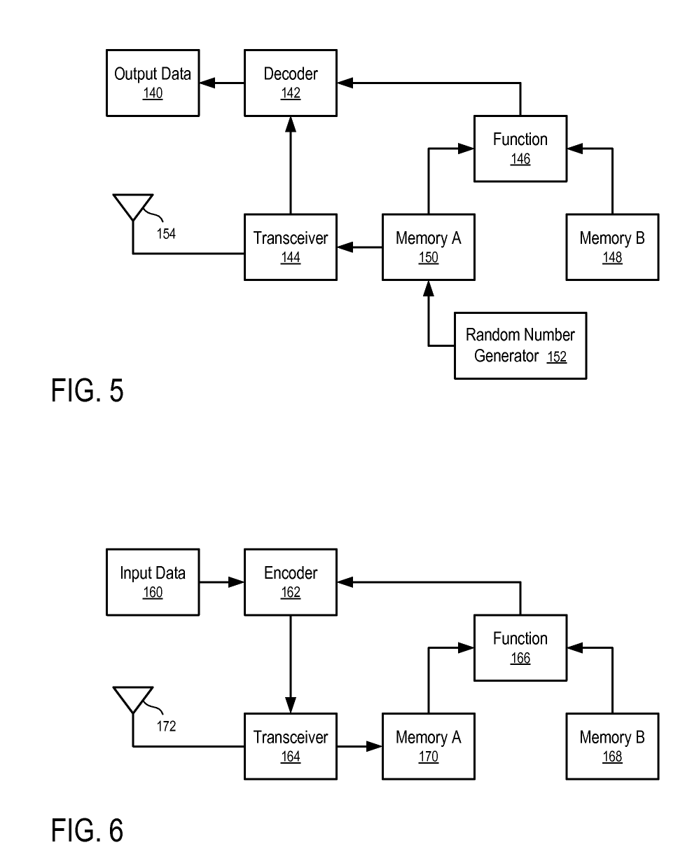

FIG. 5 shows a block diagram of a radio frequency identification (RFID) tag according to one embodiment. In FIG. 5, the tag includes a memory B (148) to store a secret and a memory A (150) to store a random number provided by the random number generator (152). Through the antenna (154) the transceiver (144) is to transmit the random number to the reader and to receive encrypted data from the reader. The logic function (146) combines the random number obtained from the memory (150) and the secret obtained from the memory (148) to generate an encryption key for the decoder (142), which decrypts the encrypted data to generate the output data (140).

In some embodiments, the radio frequency identification (RFID) tag includes an integrated circuit implementing the functions of some of the components illustrated in FIG. 5, such as the transceiver (144), the decoder (142), the logic function (146), the memory A (150), the memory B (148), and/or the random number generator (152).

In some embodiments, the decoder (142) and the logic function (146) share the same hardware circuit. For example, the logic function (146) may combine the random number obtained from the memory A (150) and the secret obtained from the memory B (148) in the same way as the decoder (142) which combines the encrypted data obtained from the transceiver (144) and the encryption key obtained from the logic function (146). Thus, when the tag is in the mode of transmitting the random number, the memory A (150) is configured to receive the random number from the random number generator (152) and the logic function (146) is used to generate the encryption key for storage back into the memory B (148); when the tag is in the mode of receiving the encrypted data, the memory A (150) is used to store the encrypted data received by the transceiver; and the logic function (146) is configured to decrypt the received data. Thus, it is not necessary to provide a separate hardware for the decoder.

In some embodiments, the memory (150) is not used; and the random number and/or the encrypted data are provided directly to the function (146).

In some embodiments, a tag is configured to be capable to transmit and/or receive encrypted data using the random number and the secret, based on a command received from the reader. In some embodiments, the tag can include further components not show in FIG. 4. Thus, the radio frequency identification (RFID) tag is not limited to a particular implementation.

In FIG. 5, the logic function (146) is used as a key generator, which can be implemented using a modular adder to generate the encryption key from the random number stored in the memory A (150) and the secret number stored in the memory B (148).

In some embodiments, the key generator can be used to replace the decoder (142) to further decrypt received encrypted data and/or to generate encrypted data using the encryption key. In one embodiment, the modular adder is implemented using a logic block to perform bitwise exclusive OR operations.

FIG. 6 shows a block diagram of a radio frequency identification (RFID) reader according to one embodiment. In FIG. 6, the reader includes a memory B (168) to store the same secret as the corresponding memory (148) of the transmitting system of FIG. 5. The memory A (170) is to store the random number obtained from the transceiver (164). The logic function (166) combines the random number obtained from the memory A (170) and the secret obtained from the memory B (168) to generate the same encryption key as the tag of FIG. 5. The encoder (162) uses the encryption key to encrypt the input data (160) for transmission by the transceiver (164) through the antenna (172).

In some embodiments, the reader further includes a decoder to decrypt the encrypted message received at the transceiver. In some embodiments, the encoder, decoder and/or the function (166) used to generate the encryption share the same hardware (e.g., a logic block to perform bitwise exclusive OR operations, or a microprocessor). In some embodiments, the reader can include further components not show in FIG. 5. Thus, the reader is not limited to a particular implementation.

In some embodiments, the components of the reader as illustrated in FIG. 6 (or the transmitting systems as illustrated in FIG. 3, the receiving system as illustrated in FIG. 4, or other systems described in the disclosure) are implemented via hardware circuit (e.g., an integrated circuit). Alternatively, at least some of the components of the reader (or transmitting systems or receiving systems) can be implemented using software executing on a general purpose or special purpose microprocessor. Thus, embodiments of the disclosure can be implemented using hardware, programs of instruction, or combinations of hardware and programs of instructions.

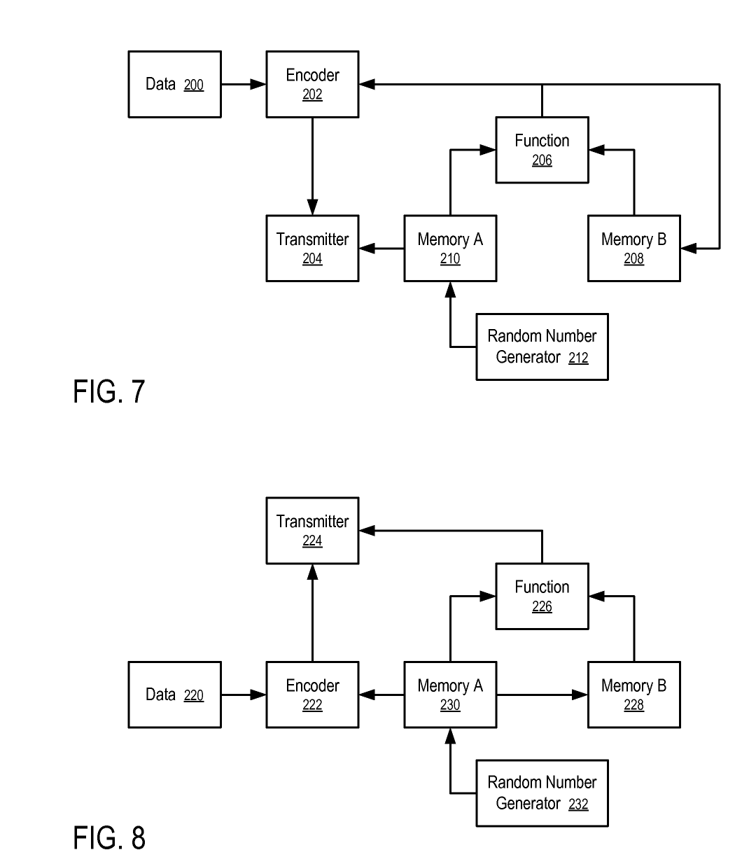

In some embodiments, the secret used to generate the encryption key is updated using the random numbers, as illustrated in FIGS. 7 and 8.

In FIG. 7, the secret stored in the memory B (208) is updated according to the random number transmitted. To transmit data (200) using the transmitter (204), the random number generator (212) provides a random number to the memory (210). The random number and the secret stored in the memory B (208) are used in the function (206) to generate an encryption key. The encryption key is stored back into the memory B (208) as the new secret for the generation of the next encryption key; and the current encryption key is used in the encoder (202) to encrypt the data (200). The transmitter (204) is configured to transmit the encrypted data and the corresponding random number.

In FIG. 7, the secret is updated in response to each transmission of the random number provided by the random number generator. Alternatively, the secret can be updated periodically or in response to a command (e.g., a command from an RFID reader or a controlling device).

In one embodiment, the random number is at least as long as the data (200). In some embodiments, the random number stored in the memory A (210) and the secret stored in the memory (B) have the same length.

In some embodiments, the same secret in the memory (208) is applied on multiple random numbers to generate multiple encryption keys which can be used as a combined encryption key that is as long as the data (200). The data (200) is divided into multiple blocks, each having a length no longer than a random number stored into the memory A (210) and each encrypted using an encryption key generated from the corresponding random number. The secret in the memory (208) can be updated after the entire data (200) is transmitted, or updated after the encryption of each block of the data (200). For example, after each random number is used to generate a segment of the combined encryption key, the new segment of the combined encryption key can be stored back into the memory B (208) as the new secret for the key generation for the next block of the data (200).

In one embodiment, the random number and the encrypted data are transmitted sequentially in separate transmissions (e.g., in response to separate requests). For example, the encrypted data is transmitted after the random number is transmitted. Alternatively, the random number and the encrypted data can be transmitted in one response, or as multiple groups of responses.

In FIG. 8, the random number generated from the random number generator (232) is not transmitted directly. Instead, the random number stored in the memory A (230) is combined with the secret stored in the memory B (228) to generate an encrypted random number using the function (226). The random number stored in the memory A (230) is used in the encoder (222) to encrypt the data (220) for transmission by the transmitter (224). The transmitter (224) is configured to send the random number encrypted using the secret and the message separately encrypted using the random number.

Since the secret stored in the memory B (228) protects the random number from the eavesdropper, the random number stored in the memory A (230) can be used to periodically update the secret stored in the memory B (228).

In another embodiment, the random number stored in the memory (230) is not used to encrypt the data (220) directly. Instead, a separate encryption key is generated using a further secret stored in a memory (not shown in FIG. 8). Thus, one secret is used to protect the transmission of the random number; and a separate secret is used to generate the encryption key based on the random number that is transmitted in an encrypted form.

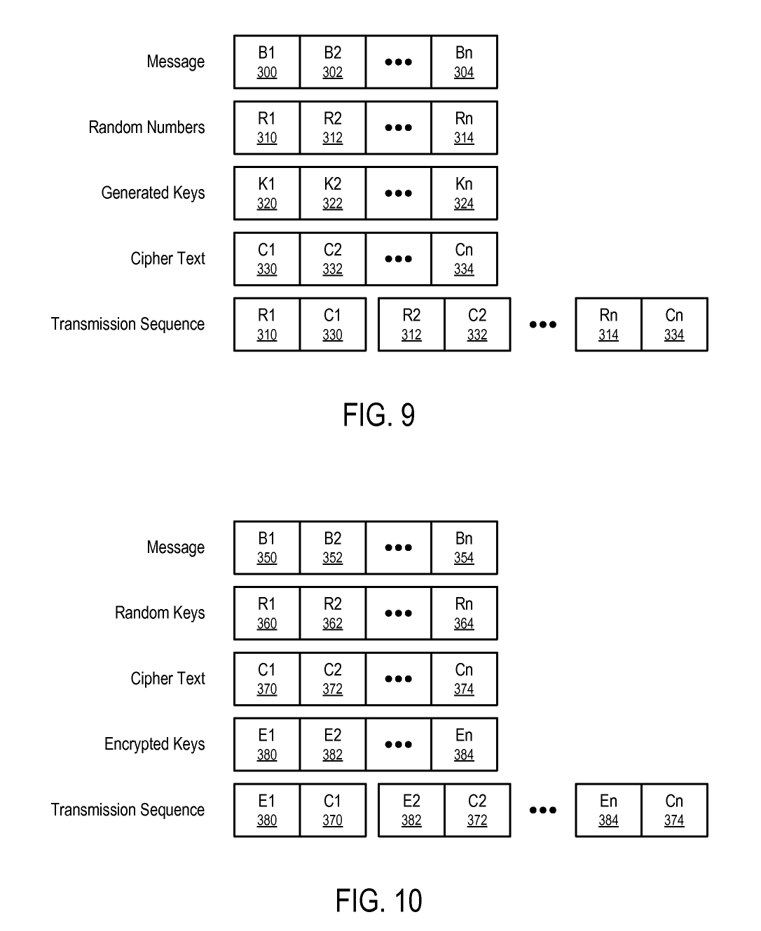

FIGS. 9 and 10 show methods to transmit blocks of a message via interleaving transmission of blocks of random numbers and blocks of cipher text.

In FIG. 9, the message is divided into a number of blocks (300, 302, . . . , 304). The same number of blocks of random numbers (310, 312, . . . , 314) are generated and transmitted (e.g., from RFID tags to a reader over the air). The random numbers are used to generate corresponding blocks of keys (320, 322, . . . , 324) using a shared secret. For example, the random number block (310) is combined with a secret to generate the key block (320) (e.g., via modular adder or bitwise exclusive OR). The generated blocks of keys (310, 332, . . . , 334) are used to encrypt the corresponding message blocks (300, 302, . . . , 304). In one embodiment, each of the message blocks, random number block, key block and the cipher text block has the same length. When the end portion of the message is shorter than the block length, the message is padded to have the same length as the random number block.

In FIG. 9, the random number blocks and the cipher text blocks are transmitted in an interleaving fashion. For example, the random number block (310) is used to generate the key block (320) which is used to encrypt the message block (300) to generate the cipher text block (330). The random number block (310) is transmitted with the cipher text block (330) as a group. Other groups of the random number blocks and corresponding cipher text blocks are transmitted sequentially thereafter. Thus, the random number blocks are interleaved between cipher text blocks; and the cipher text blocks are interleaved between the random number blocks.

In FIG. 10, the blocks of random keys (e.g., 360, 362, . . . , 364) are transmitted as encrypted blocks of the key (e.g., 380, 382, . . . , 384). The keys are encrypted using a prior shared secret and/or the prior block of the random keys. The message blocks are encrypted using the random keys. For example, message block (350) is encrypted using the random key block (360) to generate the cipher text block (380). The encrypted key block (380) is transmitted with the cipher text block (380) as a group. Other groups of encrypted key and cipher text are transmitted sequentially thereafter.

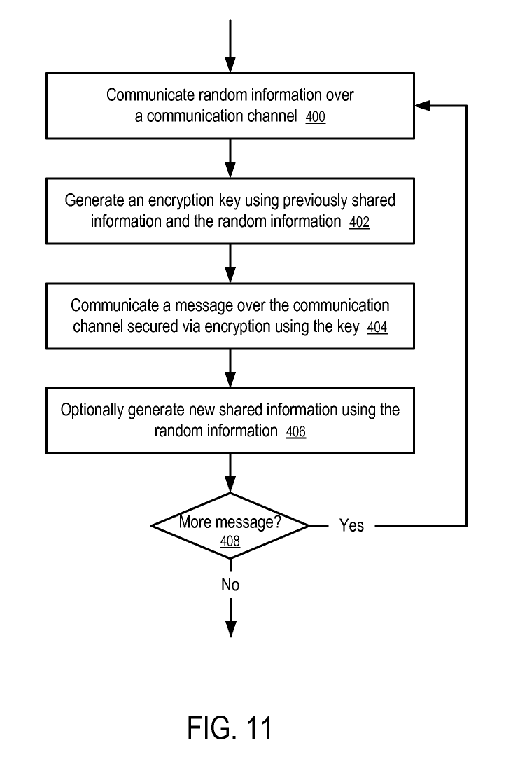

FIG. 11 shows a block diagram of a process to secure data communication according to one embodiment. In FIG. 11, random information is communicated (400) over a communication channel, such as a radio link during an RFID reader interrogating one or more RFID tags, or a network connection. An encryption key is generated (402) using previously shared information and the random information. A message is communicated (404) over the communication channel secured via encryption using the key. Optionally, new shared information is generated (406) using the random information to replace the previously shared information for the generation of the next encryption key. For example, the generated the encryption key can be used as the new shared information.

In one embodiment, the operations 400-406 are repeated for each segment of the message that has the same length of random numbers or less until the entire message is transmitted.

In one embodiment, the random information is generated and communicated over the communication channel without using the previously shared information; and the encryption key is generated via encrypting the random information using the previously shared information, or decrypting the previously shared information using the random information.

In one embodiment, the encryption key is first randomly generated and then encrypted using the previously shared information to generate the random information for transmission over the communication channel; and the encryption key is generated via decrypting the random information using the previously shared information.

In one embodiment, the message is divided into a plurality of message blocks. The random information includes a plurality of random blocks corresponding to the plurality of message blocks. The encryption key includes a plurality of key blocks corresponding to the plurality of random blocks. The communicating of the message over the communication channel includes encrypting the message blocks using the key blocks corresponding to the message blocks.

In one embodiment, the random information and the message are transmitted over the communication channel via communicating the random blocks and the encrypted message blocks in an interleaving sequence, where a subset of the random blocks is interleaved between the encrypted message blocks and a subset of the encrypted message blocks between the random blocks. In some embodiments, the random blocks are equal to or longer than the message blocks in length.

In one embodiment, the random blocks have a predetermined length; a first key block is generated from a first random block; and a second key block is generated from the first key block and a second random block.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method implemented in a radio frequency identification (RFID) system, the method comprising:
communicating random information between an RFID reader and an RFID tag during the RFID reader interrogating the RFID tag;
generating an encryption key using previously shared information and the random information; and
communicating a message between the RFID reader and the RFID tag via encryption based on the key during the RFID reader interrogating the RFID tag.

2. The method of claim 1, further comprising:
based on the random information generating new shared information to replace the previously shared information.

3. The method of claim 2, wherein the new shared information is the generated encryption key.

4. The method of claim 1, wherein the generating of the encryption key comprises the RFID reader and the RFID tag separately generating the encryption key using the previously shared information and the random information.

5. The method of claim 4, wherein the random information is generated and communicated between the RFID reader and the RFID tag without using the previously shared information; and
wherein the generating of the encryption key comprises encrypting the random information using the previously shared information.

6. The method of claim 4, wherein the random information is generated and communicated between the RFID reader and the RFID tag without using the previously shared information; and
wherein the generating of the encryption key comprises decrypting the previously shared information using the random information.

7. The method of claim 1, further comprising:
the RFID tag randomly generating the encryption key;
the RFID encrypting the key using the previously shared information to generate the random information;
wherein the generating of the encryption key comprises the reader decrypting the random information using the previously shared information.

8. A radio frequency identification (RFID) system, comprising:
an RFID tag; and
an RFID reader, the tag to transmit random information to the reader in response to the reader interrogating the tag, the tag and the reader to generate an encryption key using a shared secret and the random information and to communicate a message via encryption based on the key.

9. The radio frequency identification (RFID) system of claim 8, wherein the RFID tag and the RFID reader use the encryption key to replace the previously shared information after the message encrypted using the encryption key is communicated between the RFID tag and the RFID reader.

10. The radio frequency identification (RFID) system of claim 8, wherein the random information is generated and communicated between the RFID reader and the RFID tag without using the previously shared information.

11. The radio frequency identification (RFID) system of claim 8, wherein the tag further comprises:
an antenna;
a transceiver coupled to the antenna;
a memory to store the shared secret; and
a controller coupled to the memory and transceiver, the controller including a random number generator and a key generator;
wherein, in response to a request received from the RFID reader via the antenna and the transceiver, the random number generator is to generate the random information for transmission by the transceiver as a response to the request, and the key generator to generate the encryption key using the random information and the shared secret stored in the memory.

12. The radio frequency identification (RFID) system of claim 11, wherein the key generator comprises a logic function to generate the encryption key from the random information and the shared secret stored in the memory.

13. The radio frequency identification (RFID) system of claim 12, wherein the logic function is to further encrypt the message using the encryption key for transmission by the transceiver and the antenna to the RFID reader.

14. The radio frequency identification (RFID) system of claim 12, wherein the logic function is to decrypt encrypted message, received via the antenna and the transceiver from the RFID reader, using the encryption key.

15. The radio frequency identification (RFID) system of claim 8, wherein the RFID reader further comprises:
a transceiver coupled to an antenna;
a memory to store the shared secret;
a processor coupled to the memory and transceiver to transmit a request signal to the RFID tag for the random information;
wherein responsive to the transceiver receiving the random information from the RFID tag, the processor is to generate the encryption key using the random information and the shared secret stored in the memory.

16. The radio frequency identification (RFID) system of claim 15, wherein the processor is to encrypt the message using the generated key for transmission to the RFID tag via the transceiver.

17. The radio frequency identification (RFID) system of claim 15, wherein the transceiver is to receive encrypted message from the RFID tag, and the processor is to use the key to decrypt the received encrypted message.

18. A radio frequency identification (RFID) tag, comprising:
an antenna;
a transceiver coupled to the antenna;
a memory to store a number; and
a controller coupled to the memory and transceiver, the controller including a random number generator and a key generator;
wherein, in response to a request received via the antenna and the transceiver, the random number generator is to generate a random number for transmission by the transceiver as a response to the request, and the key generator to generate an encryption key using the random number and the number stored in the memory.

19. The radio frequency identification (RFID) tag of claim 18, wherein the key generator comprises a modular adder to generate the encryption key from the random number and the number stored in the memory.

20. The radio frequency identification (RFID) tag of claim 19, wherein the modular adder is to further generate encrypted data using the encryption key for transmission by the transceiver and the antenna.

21. The radio frequency identification (RFID) tag of claim 19, wherein the modular adder is to decode a subsequent message, received via the antenna and the transceiver, using the encryption key.

22. The radio frequency identification (RFID) tag of claim 19, wherein the modular adder comprises a logic block to perform bitwise exclusive OR operations.

23. A radio frequency identification (RFID) reader, comprising:
a transceiver coupled to an antenna;
a memory to store a number; and
a processor coupled to the memory and transceiver to transmit a request signal to an RFID tag for a random number;
wherein responsive to the transceiver receiving the random number from the RFID tag, the processor is to generate an encryption key using the random number and the number stored in the memory.

24. The radio frequency identification (RFID) reader of claim 23, wherein the processor is to encrypt data using the generated key for transmission to the RFID tag via the transceiver.

25. The radio frequency identification (RFID) reader of claim 23, wherein the transceiver is to receive encrypted data from the RFID tag, and the processor is to use the key to decrypt the received encrypted data.

26. A machine readable media embodying instructions, the instructions causing a radio frequency identification (RFID) reader to perform a method, the method comprising:
communicating random information over a communication channel;
generating an encryption key using previously shared information and the random information; and
communicating over the communication channel a message via encryption based on the key.

27. A method implemented in a data communication system, the method comprising:
communicating random information over a communication channel;
generating an encryption key using previously shared information and the random information; and
communicating over the communication channel a message via encryption based on the key.

28. The method of claim 27, further comprising:
dividing the message into a plurality of message blocks;
wherein the random information includes a plurality of random blocks corresponding to the plurality of message blocks;
wherein the encryption key includes a plurality of key blocks corresponding to the plurality of random blocks; and
wherein the communicating of the message over the communication channel comprises encrypting the message blocks using the key blocks corresponding to the message blocks.

29. The method of claim 28, wherein the communicating of the random information and the communicating of the message comprise communicating the random blocks and the encrypted message blocks in an interleaving sequence with a subset of the random blocks interleaved between the encrypted message blocks and a subset of the encrypted message blocks interleaved between the random blocks.

30. The method of claim 29, wherein the random blocks are equal to or longer than the message blocks in length.

31. The method of claim 29, wherein the random blocks have a predetermined length; a first key block is generated from a first random block; and a second key block is generated from the first key block and a second random block.
